(19) United States
(12) Patent Application Publication
(10) Pub. No.: US 2025/0301441 A1
(43) Pub. Date: Sep. 25, 2025

(54) DYNAMIC RECONFIGURATION OF WI-FI MODES FOR ROUND TRIP TIME (RTT)

(71) Applicant: QUALCOMM Incorporated, San Diego, CA (US)

(72) Inventors: Robert James ANDERSON, Bryn Mawr, PA (US); Sergii GALAT, Dorchester, MA (US)

(21) Appl. No.: 18/610,970

(22) Filed: Mar. 20, 2024

(51) Int. Cl. H04W 64/00; H04W 24/08

(52) U.S. Cl. CPC H04W 64/003; H04W 24/08

(57) ABSTRACT

A management entity (ME) for determining a location of a wireless target device (WTD), where the ME is in signal communication with a plurality of base stations that are each in signal communication with a plurality of wireless client devices. The ME comprises at least one transceiver, at least one memory, and at least one processor. The at least one processor is configured to: obtain mine a coarse location of the WTD; and transmit a mode change command to at least one wireless client device, located near the WTD to switch to a beacon mode based on the coarse location of the WTD.

### BACKGROUND

Wireless devices have become commonplace in modern society and many of these wireless devices are utilized in both commercial, retail, and home environments. Generally, many of these wireless devices are wirelessly connected to servers or other communication devices within these environments.

In retail environments, some of these wireless devices may be wireless retail sensors that are physically attached to retail products. In general, brick-and-mortar retail establishments have a common need to monitor the location and/or movement of store merchandise and business assets. Retail establishment personnel need to know where merchandise is located, where it is supposed to be, and when it is being moved to a location where it should not be. As an example, unauthorized movement of merchandise could indicate a theft in progress, or it might be a well-intentioned employee moving something to the wrong location. Either way, the result could be stolen merchandise, a lost sale when the desired item can't be found, or lost productivity as employees are occupied by inventory checks to locate misplaced merchandise.

At present, some retail establishments utilize cameras and/or wireless tags to monitor and locate specific merchandise. Examples include a plurality of Wi-Fi enabled wireless cameras pointed at tables or shelves of merchandise to be monitored and Wi-Fi enabled real-time locating system (RTLS) tags, physically attached to the merchandise, that utilize received signal strength indicators (RSSI) and time difference of arrival (TDoA) mechanisms to determine the location of the merchandise via the RTLS tags.

In these examples, the Wi-Fi enabled cameras and RTLS tags are wireless connected to a plurality of Wi-Fi access points (APs) that communicate with these Wi-Fi enabled devices and a remote entity that may include a location server configured to determine the location of the merchandise being monitored. A problem with this approach is that many times the Wi-Fi APs are not in line-of-sight (LOS) with the merchandise being monitored, which may result in a lack of accuracy (of, for example, 3 to 10 meters) in determining the location of the merchandise being monitored. The resulting lack of accuracy may be inadequate for properly locating the merchandise being monitored.

### SUMMARY

Techniques and systems discussed in the present disclosure include a management entity (ME) for determining a location of a wireless target device (WTD), where the ME is in signal communication with a plurality of base stations that are in signal communication with a plurality of wireless client devices. The ME comprises: at least one transceiver; at least one memory; and at least one processor, in signal communication with the at least one transceiver, and the at least one memory. The at least one processor configured to: obtain a coarse location of the WTD; and transmit a beacon mode command to at least one wireless client device, of the plurality of wireless client devices, located near the WTD to switch to a beacon mode based on the coarse location of the WTD.

A method is also discussed for determining the location of the WTD with the ME, where the ME is in signal communication with a plurality of base stations that are in signal communication with a plurality of wireless client devices. The method comprises: obtaining a coarse location command to the WTD to determine a coarse location of the WTD utilizing the plurality of base stations; and transmitting a beacon mode command to at least one wireless client device of the plurality of wireless client devices, located near the WTD to switch to a beacon mode based on the coarse location of the WTD.

Furthermore, a WTD is discussed and comprises: at least one transceiver; at least one memory; and at least one processor, in signal communication with the at least one transceiver, and the at least one memory. The at least one processor configured to: receive, with the at least one transceiver, a coarse location command from a management entity (ME); determine a coarse location of the WTD utilizing a plurality of base stations based on the coarse location command; receive a fine location command from the ME based on the coarse location of the WTD; measure fine positional data from beacon signals of at least one wireless client device based on the fine location command, wherein the at least one wireless client device is in a beacon mode; and transmit, with the at least one transceiver, the fine location of the WTD or fine positional data to the ME, wherein the fine location is based on the fine positional data.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE DRAWINGS

FIG. 1 is a functional system block diagram of an example of an implementation of dynamic reconfigurable mode system (DRMS) for determining a location of a wireless target device (WTD) utilizing round trip time (RTT).

FIG. 2 is the functional system block diagram of the DRMS shown in FIG. 1 illustrating an example of an implementation of a method for determining the location of the WTD.

FIG. 3 is a sequence diagram illustrating an example of an RTT procedure performed by the WTD and at least one wireless client devices shown in FIGS. 1 and 2.

FIG. 4 is a system block diagram of an example of an implementation the WTD, shown in FIGS. 1 and 2, for use with merchandise.

FIG. 5 is a system block diagram of an example of an implementation of a user equipment (UE) incorporating the Management Entity (ME) shown in FIGS. 1 and 2.

FIG. 6 is a sequence diagram illustrating an example of an implementation of operation of the DRMS shown in FIGS. 1 and 2.

FIG. 7 is a functional system block diagram of an example of an implementation of the DRMS, shown in FIGS. 1 and 2, within a commercial environment.

FIG. 8 is a functional system block diagram of an example of an implementation of the DRMS, shown in FIGS. 1 and 2, within a commercial environment utilizing the UE shown in FIG. 5.

FIG. 8 is a functional system block diagram of a UE in the commercial environment shown in FIG. 7.

FIG. 9 is a flowchart diagram of an example of an implementation of method performed by the ME of FIGS. 1, 2, and 3.

FIG. 10 is a flowchart diagram of an example of an implementation of method performed by the WTD of FIGS. 1, 2, and 3.

### DETAILED DESCRIPTION

Techniques are discussed for determining a location of a wireless target device (WTD) with a management entity (ME) with a dynamic reconfigurable mode system (DRMS). The ME is in signal communication with a plurality of base stations that are in signal communication with a plurality of wireless client devices. These techniques may include dynamically reconfiguring selected wireless client devices of the plurality of wireless client devices for round trip time (RTT) measurements between the WTD and the selected wireless client devices to assist in localization ranging of the WTD. As an example, the WTD, plurality of base stations, and plurality of wireless client devices may be wireless fidelity (Wi-Fi) devices operating in and connected to a Wi-Fi network.

In one embodiment, the ME may provide assistance data that indicates media access control (MAC) address and the time each base station (e.g., a Wi-Fi/Bluetooth device) is switching to an access point (AP) mode to aid in localization, the WTD may use this assistance data to perform localization ranging with the temporal AP mode device (i.e., the base station).

As an example, the ME may include at least one transceiver; at least one memory; and at least one processor, in signal communication with the at least one transceiver, and the at least one memory. The at least one processor of the ME may be configured to: transmit a coarse location command to the WTD to determine a coarse location of the WTD utilizing the plurality of base stations; transmit a beacon mode command to at least one wireless client device of the plurality of wireless client devices, located near the WTD to switch to a beacon mode based on the coarse location of the WTD; and transmit a fine location command to the WTD to determine a fine location of the WTD utilizing the at least one wireless client device.

As another example, the WTD may also include at least one transceiver; at least one memory; and at least one processor, in signal communication with the at least one transceiver, and the at least one memory. The at least one processor of the WTD may be configured to: receive, with the at least one transceiver, the coarse location command from the ME; determine the coarse location of the WTD utilizing the plurality of base stations based on the coarse location command; receive the fine location command from the ME based on the coarse location of the WTD; measure fine positional data from beacon signals of the at least one wireless client device based on the fine location command, where the at least one wireless client device is in a beacon mode; and transmitting, with the at least one transceiver, the fine location of the WTD or fine positional data to the ME.

As an example of Wi-Fi client devices within a Wi-Fi network, the techniques discussed herein enable fixed Wi-Fi connected wireless client devices, which normally operate in a station mode for their primary function, to operate in other modes to support location of the WTD. Examples of these other modes may include, for example, Wi-Fi AP, Wi-Fi Aware, Wi-Fi Direct, or other similar techniques. In the example of Wi-Fi wireless client devices, these Wi-Fi wireless client devices may periodically, or on demand, function as Wi-Fi RSSI or RTT positioning beacons for the WTD.

In an example of operation within a Wi-Fi network, these techniques may utilize the ME to coordinate the location of the WTD, where the ME transmits a command to relevant (i.e., selected) Wi-Fi wireless client devices to switch from the normal station mode to a mode supporting Wi-Fi RTT such as, for example, the AP mode. The ME also transmits to the WTD the MAC addresses and time duration of the AP mode for each Wi-Fi wireless client device that will be in the AP mode. The WTD then initiates RTT measurements with each Wi-Fi wireless client device while these Wi-Fi wireless client devices are in the AP mode. The RTT measurements may then be utilized to locate the WTD. After the RTT measurements are complete, the Wi-Fi wireless client devices may then switch from the AP mode to return to the station mode. In this example, the selected Wi-Fi wireless client devices may return to the station mode via a time out of the time duration of the AP mode or as the result of receiving another command from the ME instructing the selected Wi-Fi wireless client devices to return to the station mode.

In this disclosure, the other modes of operation of the wireless client devices (such as, for example, the AP mode, Wi-Fi Aware, Wi-Fi Direct, etc.) may be generally referred to as a beacon mode operation for the wireless client devices. In a Wi-Fi related example, the Wi-Fi beacon mode may be enabled when needed to locate the WTD and may be precisely coordinated by the ME to a time when the WTD will initiate beacon measurements from the Wi-Fi wireless client devices. In this example, the beacon mode selection for the Wi-Fi wireless client devices may be based on previous knowledge of the location of the WTD to minimize the number of beacons utilized in the WTD location process. The beacon mode selection may be utilized to provide a desired accuracy for the location of the WTD that takes into account geometric dilution of precision (GDOP), expected RTT measurement accuracy, and any desired location accuracy.

As a further example of operation, the ME may command the WTD to determine a coarse location first utilizing multiple Wi-Fi base stations (also generally referred to as Wi-Fi APs). Once the coarse location of the WTD is determined, the ME may then select a sub-plurality of Wi-Fi wireless client devices to provide good coverage and GDOP across an area of the coarse location. The ME may then command the Wi-Fi wireless client devices to switch from the station mode to the beacon mode (e.g., AP mode) and command the WTD to position itself utilizing the Wi-Fi wireless client devices of the ME selected sub-plurality of Wi-Fi wireless client devices. Once the position of the WTD is determined, the Wi-Fi wireless client devices are then switched back to the station mode of operation.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB/gNB). In addition, in some systems a base station may provide purely edge node signaling functions while in other systems it may provide additional control and/or network management functions. As another example, a base station may be a Wi-Fi device that is configured to operate in an AP mode where other wireless client devices (i.e., Wi-Fi enabled devices), configured in a station mode (STA) (also known as a client mode), may connect to the base station (i.e., a Wi-Fi AP) joining an existing Wi-Fi network of which the base station is part of.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

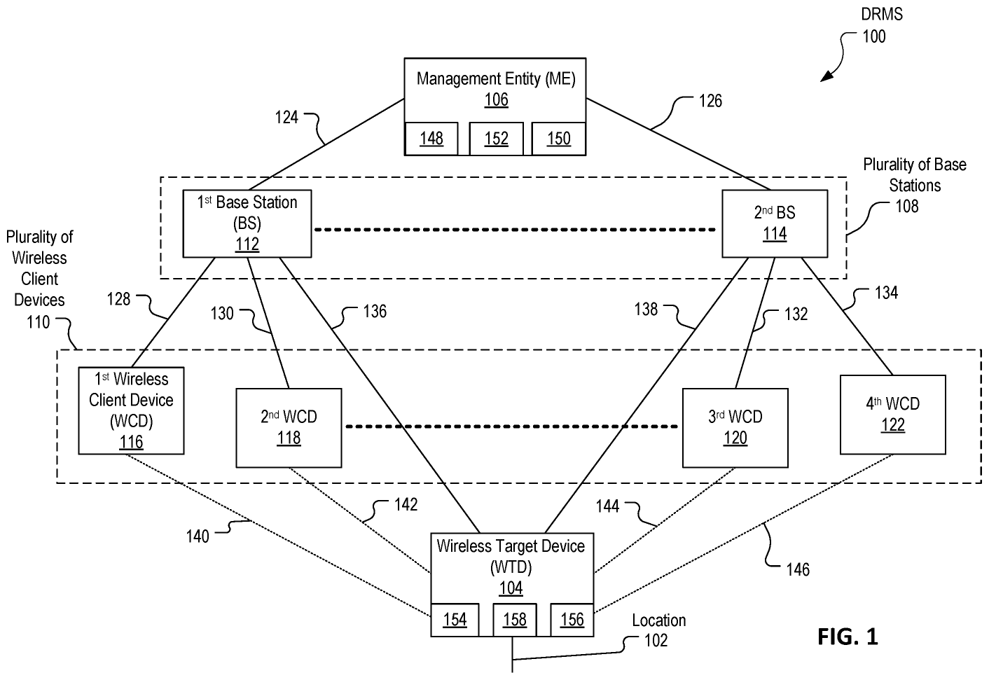

In FIG. 1, a functional system block diagram is shown of an example of an implementation of a DRMS 100 for determining a location 102 of a WTD 104 utilizing RTT accordance with the present disclosure. The DRMS 100 may include the WTD 104, a ME 106, a plurality of base stations 108, and a plurality of wireless client devices 110. In this example, the plurality of base stations 108 and the plurality of wireless client devices 110 may, respectively, include any number of base stations and wireless client device but for the case of illustration, only two base stations (i.e., a first base station (1^{st} BS) 112 and a second base station (2^{nd} BS) 114) and only four wireless client devices (i.e., a first wireless device (1^{st} WCD) 116, a second wireless device (2^{nd} WCD) 118, a third wireless device (3^{rd} WCD) 120, and a fourth wireless device (4^{th} WCD) 122) are shown.

In this example, each of the wireless client devices, of the plurality of wireless client device 110, may be in signal communication with one or more base stations of the plurality of base stations 108 and the ME 106 may be in signal communication with each of the plurality of base stations 108; and each of the wireless client devices 110 through the plurality of base stations 108. The ME 106 may also be in signal communication with the WTD 104 via the plurality of wireless client devices 110 and the plurality of base stations 108. As an example, the ME 106 may be in signal communication with 1^{st} BS 112 and 2^{nd} BS 114 via signal paths 124 and 126, respectively. The 1^{st} BS 112 may be in signal communication with the 1^{st} WCD 116 and 2^{nd} WCD 118 via signal paths 128 and 130, respectively; and the 2^{nd} BS 114 may be in signal communication with the 3^{rd} WCD 120 and 4^{th} WCD 122 via signal paths 132 and 134, respectively. At least one of the base stations, of the plurality of base stations 108 (i.e., the 1^{st} BS 112 and/or 2^{nd} BS 114), may be in signal communication with the WTD 104 via signal paths 136 and 138, respectively. Moreover, the WTD 104 may be optionally in signal communication with at least one wireless client device of the plurality of wireless client device 110 (i.e., 1^{st} WCD 116, 2^{nd} WCD 118, 3^{rd} WCD 120, and/or 4^{th} WCD 122) via optional signal paths 140, 142, 144, and 146, respectively.

In this example, the ME 106 may include at least one transceiver 148; at least one memory 150; and at least one processor 152, in signal communication with the at least one transceiver 148, and the at least one memory 150. The WTD 104 may also include at least one transceiver 154; at least one memory 156; and at least one processor 158, in signal communication with the at least one transceiver 154, and the at least one memory 156.

The circuits, components, modules, and/or devices of, or associated with, the first DRMS 100 and other devices are described as being in signal communication and/or communicatively coupled with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings.

Additionally, signal paths may be non-physical such as free-space (in the case of electromagnetic propagation) or information paths through digital components where communication information may be passed from one circuit, component, module, and/or device to another in varying digital formats without passing through a direct electromagnetic connection.

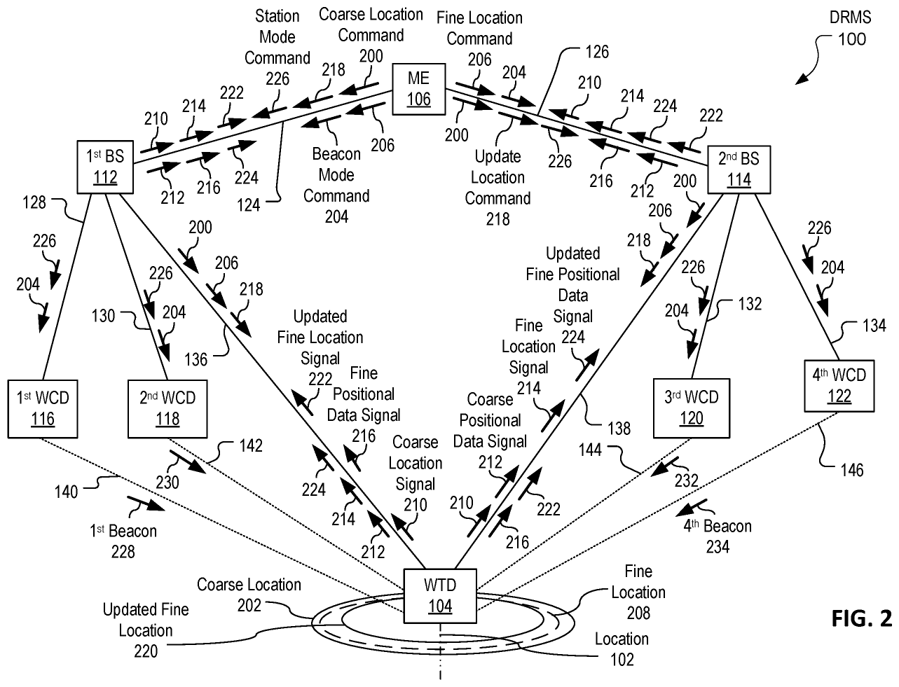

Turning to FIG. 2, a functional system block diagram of the DRMS 100 is shown performing an example of an implementation of a method for determining the location 102 of the WTD 104 accordance with the present disclosure. As an example of the operation, the at least one processor 152 of the ME 106 may be configured to: transmit a coarse location command 200 to the WTD 104 to determine a coarse location 202 of the WTD 104 utilizing the plurality of base stations 108; transmit a beacon mode command 204 to at least one wireless client device (i.e., a 1^{st} WCD 116, 2^{nd} WCD 118, 3^{rd} WCD 120, and/or 4^{th} WCD 122) of the plurality of wireless client devices 110, located near the location 102 of the WTD 104 to switch to a beacon mode based on the coarse location 202 of the WTD 104; and transmit a fine location command 206 to the WTD 104 to determine a fine location 208 of the WTD 104 utilizing the at least one wireless client device. In this example, the fine location 208 is a more precise estimate of the actual location 102 of the WTD 104 compared to the coarse location 202.

As an example, if the DRMS 100 is part of a Wi-Fi communication network, the plurality of base stations 108 may be Wi-Fi APs and the plurality of wireless client devices 110 may be Wi-Fi wireless client devices that normally operate in the station mode and are in signal communication with one or more base stations of the plurality of base stations 108. In this example, the ME 106 selected wireless client devices, of the plurality of wireless client devices 110, may periodically, or on demand, function as Wi-Fi RTT positioning beacons for the WTD 104.

In an example of operation, the DRMS 100 may utilize the ME 106 to determine the location of the WTD 104 by transmitting the beacon mode command 204 to the relevant (i.e., the ME 106 selected) Wi-Fi wireless client devices (i.e., a 1^{st} WCD 116, 2^{nd} WCD 118, 3^{rd} WCD 120, and/or 4^{th} WCD 122) to switch to a mode (i.e., the beacon mode) supporting Wi-Fi RTT such as, for example, an AP mode. The ME 106 may also transmit, to the WTD 104, the MAC addresses and time duration for the AP mode to each Wi-Fi wireless client device that will be in the beacon mode. The WTD 104 may then initiate RTT measurements with each of the selected Wi-Fi wireless client devices in the beacon mode while the selected Wi-Fi wireless client devices are in the beacon mode. These RTT measurements may be utilized approximately determine the location 102 of the WTD 104 by the WTD 104 and/or the ME 106. After the RTT measurements are complete, the Wi-Fi wireless client devices may then switch modes from the beacon mode and return back to the normal station mode. In this example, the selected Wi-Fi wireless client devices may return to the station mode via a time out of the time duration of the AP mode or as the result of receiving another command from the ME 106 instructing the selected Wi-Fi wireless client devices to return to the station mode.

In this example, the beacon mode may be enabled by the ME 106 when needed to locate the WTD 104 and may be precisely coordinated by the ME to a time when the WTD 104 will initiate beacon RTT measurements from the beacon signals from the selected Wi-Fi wireless client devices. The beacon mode selection for the selected Wi-Fi wireless client devices (i.e., a sub-plurality of wireless client devices) of the plurality of wireless client devices 110 may be based on previous knowledge of the location 102 of the WTD 104 to minimize the number of beacons utilized. The beacon selection may be utilized to provide a desired accuracy for the location 102 of the WTD 104 that considers GDOP, expected RTT measurement accuracy, and any desired location accuracy.

In general, the beacon signals are wireless signals (such as, for example, Wi-Fi signals) produced and transmitted by each of the wireless client devices when the wireless client devices are in a beacon mode of operation. The beacon signals may be a type of wireless signals that indicates the proximity or location of a specific wireless client device to the WTD 104 or its readiness to perform a task with the WTD 104.

In this Wi-Fi related example, the beacon mode may be a Wi-Fi AP mode of operation for each of the wireless client devices that is configured to allow the WTD 104 to connect to the individual wireless client devices (e.g., 1^{st} WCD 116, 2^{nd} WCD 118, 3^{rd} WCD 120, or 4^{th} WCD 122) and get ranging information via a first beacon signal (1^{st} beacon 228) along signal path 140, second beacon signal (2^{nd} beacon 230) along signal path 142, third beacon signal (3^{rd} beacon 232) along signal path 144, and fourth beacon signal (4^{th} beacon 234) along signal path 146, respectively.

As a further example of operation, the ME 106 may command (i.e., via the coarse location command 200) the WTD 104 to determine the coarse location 202 of the WTD 104 utilizing multiple Wi-Fi APs (i.e., the sub-plurality of wireless client devices of the plurality of wireless client devices 110). Once the coarse location 202 of the WTD 104 is determined, the ME 106 may then select the Wi-Fi wireless client devices (i.e., the sub-plurality of wireless client devices) to provide a good coverage and GDOP across an area of the coarse location 202. The ME 106 may then command (i.e., via the beacon mode command 204) the Wi-Fi wireless client devices to operate in a beacon mode and then command the WTD 104 to position itself using the ME 106 selected Wi-Fi client devices. Once the position of the WTD 104 is determined, the Wi-Fi client devices may then switch back from the beacon mode to the station mode of operation.

As a further example of operation, the ME 106 may be also configured to receive the coarse location 202 of the WTD 104 from the WTD 104 via a coarse location signal 210 or coarse positional data from the WTD 104 via a coarse positional data signal 212. If the ME 106 receives the coarse positional data, instead of the coarse location signal 210, the ME 106 may be configured to determine the coarse location 202 of the WTD 104. Additionally, the ME 106 may also be configured to receive the fine location 208 of the WTD 104 from the WTD 104 via a fine location signal 214 or fine positional data from the WTD 104 via a fine positional data signal 216. If the ME 106 receives the fine positional data signal 216, instead of the fine location signal 214, the ME 106 may be configured to determine the fine location 208 of the WTD 104 from fine positional data received from the WTD 104 via the fine positional data signal 216.

In this example, the fine location command 206 may include a first message that includes a MAC for the at least one wireless client device (e.g., 1^{st} WCD 116, 2^{nd} WCD 118, 3^{rd} WCD 120, and/or 4^{th} WCD 122) and a time duration of the beacon mode of the at least one wireless client device. The first message may also include additional information such as, for example, channel number, bandwidth, and preamble type.

In this example, the ME 106 may determine the fine location 208 of the WTD 104 from fine positional data by performing at least one ranging estimation between the WTD 104 and at least one wireless client device. Moreover, the beacon mode command 204 may be transmitted to a sub-plurality of the wireless client devices (of the plurality of wireless devices 110) based on a pre-determined positional accuracy for the location 102 of the WTD 104 and a pre-determined accuracy of at least one ranging estimation based on the RTT measurement between the WTD 104 and the sub-plurality of the wireless client devices. In this example, the RTT measurement may be based on a fine time measurement (FTM) between the WTD 104 and sub-plurality of the wireless client devices.

As an example, FTM enables two stations to estimate the physical distance between them; and, in general, Wi-Fi RTT enables supporting devices to measure a distance to other supporting devices whether they are APs or other Wi-Fi peers on the Wi-Fi network. In general, FTM utilizes radio frequency (RF) based two-way time-of-flight (ToF) estimation for indoor ranging and positioning. Utilizing Wi-Fi RTT allows devices in Wi-Fi network to measure distance to nearby Wi-Fi APs to determine their respective location with a precision of approximately 1 to 2 meters. Generally, RTT signal measurements between the WTD 104 and a single Wi-Fi wireless client device in the beacon mode determine the approximate distance between the WTD 104 and the Wi-Fi wireless client device but if the WTD 104 performs multiple RTT measurements between the WTD 104 and multiple Wi-Fi wireless client devices, a positional system in the WTD 104 and/or ME 106 may determine the approximate location of the WTD 104 by trilateration that utilizes the known locations of the multiple Wi-Fi wireless client devices and the distances from the these multiple Wi-Fi wireless client devices to the WTD 104 to perform localisation. As an example, the use of Wi-Fi RTT may be described by the IEEE 802.11mc protocol or later.

As another example, the ME 106 may be further configured to transmit an update location command 218 to the WTD 104 to determine an updated fine location 220 of the WTD 104 utilizing at least one wireless client device. In this example, the ME 106 may either receive the updated fine location 220 of the WTD 104 from the WTD 104 via an updated fine location signal 222 or determine the updated fine location 220 of the WTD 104 from the updated fine positional data received from the WTD 104 via an updated fine positional data signal 224.

In these examples, the ME 106 may transmit the beacon mode command 204 to the at least one wireless client device directly without consideration of the activity being performed, if any, by the at least one wireless client device or by first considering the activities being performed by the at least one wireless client device and then scheduling the transmission of the beacon mode command 204 when the at least one wireless client device is ready to switch modes. In this example, the ME 106 may be further configured to query the at least one wireless client device for availability to switch to the beacon mode, and then determine to either transmit the beacon mode command 204 if the at least one wireless client device is available to switch or schedule the transmission of the beacon mode command 204 if the at least one wireless client device is not available to switch. Further, the ME 106 may also be configured to transmit a station mode command 226 to the at least one wireless device to switch back from the beacon mode to a station mode.

As another example, the ME 106 may be configured on a UE, where the UE may include a location determination device configured to determine a position for the UE. In this example, the ME 106 is configured to determine the fine location 208 of the WTD 104 as previously discussed; and determine the fine location 208 of the WTD 104 relative to the position of the UE.

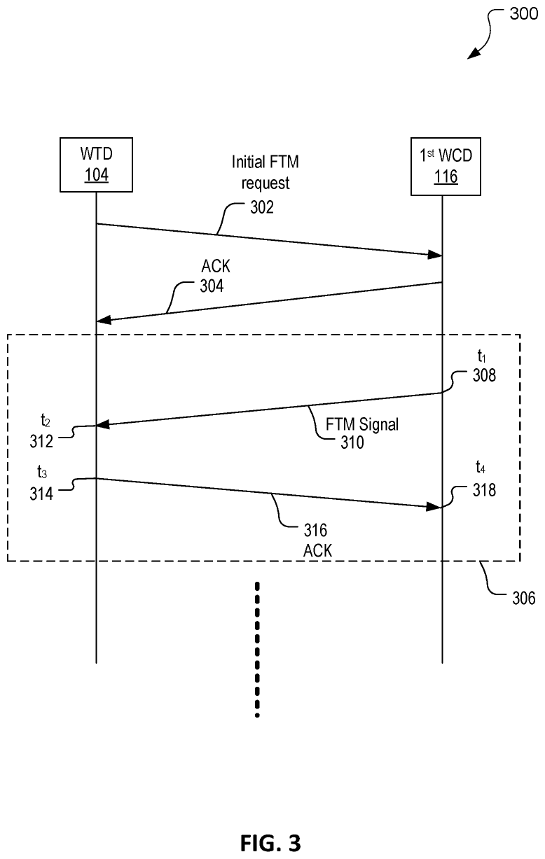

In FIG. 3, a sequence diagram 300 is shown illustrating an example of an RTT procedure performed by the WTD 104 and at least one wireless client device. In this example, the at least one wireless client device is shown as the 1^{st} WCD 116 and WTD 104 will utilize FTM measurements for the RTT procedure. In an example of operation, the WTD 104 is configured and acts as an initiating entity transmitting an initial FTM request signal 302 to the 1^{st} WCD 116 that is configured to act as a responding entity. In this example, the WTD 104 initially requests a FTM measurement from the 1^{st} WCD 116. The 1st WCD 116 receives the request signal 302 for the FTM measurement and in response transmits an acknowledgement (ACK) signal 304. The 1^{st} WCD 116 and WTD 104 then enter into a FTM procedure 306 that includes transmitting to the WTD 104, at a first time (t₁) 308, an FTM signal 310. The WTD 104 receives the FTM signal 310 at a second time (t₂) 312 that has a time delay compared to the t₁ 308 based on the propagation time from the 1^{st} WCD 116 to the WTD 104. The WTD 104 then transmits to the 1^{st} WCD 116, at a third time (t₃) 314, an acknowledgement signal 316. In this example, the t₃ 314 has another time delay compared to the t₂ 312 that may be the result of the internal electronics and/or processing delay of the WTD 104. The 1^{st} WCD 116 then receives the acknowledgement signal 316 at a fourth time (t₄) 318 that has yet another time delay compared to the t₃ 314 that is based on the propagation time from the WTD 104 to the 1^{st} WCD 116. From these times and time delays, the WTD 104 may calculate its distance from the 1^{st} WCD 116. Utilizing this procedure with additional wireless client device, the WTD 104 is configured to determine the approximate location 102 (i.e., the fine location 208) of the WTD 104 via trilateration.

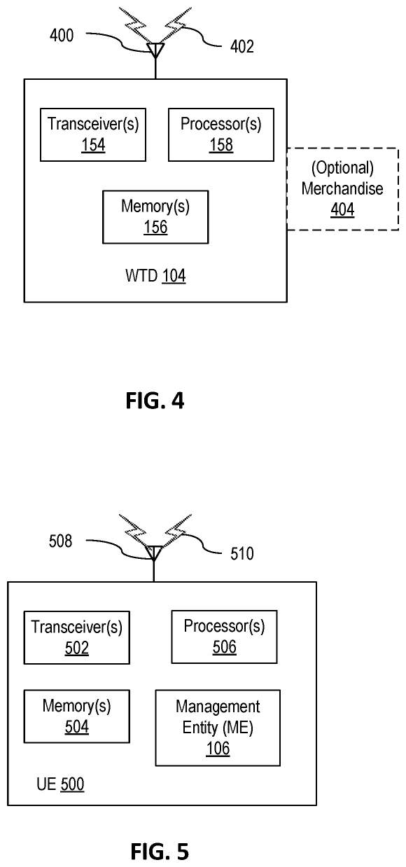

In FIG. 4, a system block diagram of an example of an implementation the WTD 104 is shown for use with merchandise in a commercial environment accordance with the present disclosure. As described previously, the WTD 104 may include at least one transceiver 154, at least one memory 156, and at least one processor 158. The WTD 104 may also include at least one antenna 400 for transmitting and receiving a plurality of WTD RF signals 402 to at least one base station of the plurality of base stations 108 and at least one wireless client device of the plurality of wireless client devices 110. In this example, the WTD 104 may be tag that may be attached to an optional piece of merchandise 404. By attaching to the merchandise 404, the WTD 104 may be utilized to locate and/or secure the merchandise 404 in a commercial environment such as a store. Utilizing the WTD 104 in this commercial environment would allow employees or buyers (both potential and actual) of a business to find the merchandise 404 attached to the WTD 104 in, for example, a store shelve and prevent it from being lost or stolen.

FIG. 5 is a system block diagram of an example of an implementation of a UE 500 incorporating the ME 106 in accordance with the present disclosure. In this example, in addition to the ME 106, the UE 500 may include at least one transceiver 502, at least one memory 504, at least one processor 506, and at least one antenna 508. The at least one antenna 508 is configured to transmit and receiving a plurality of UE RF signals 510. In this example, the ME 106 may be in signal communication with and utilize the at least one transceiver 502, at least one memory 504, at least one processor 506 as the at least one transceiver 148, at least one memory 150, at least one processor 152 shown in and described in relation to FIGS. 1 and 2. In this example, the ME 106 may be a hardware device/component within the UE 500 or a software application that is run by the at least one processor 506 of the UE 500.

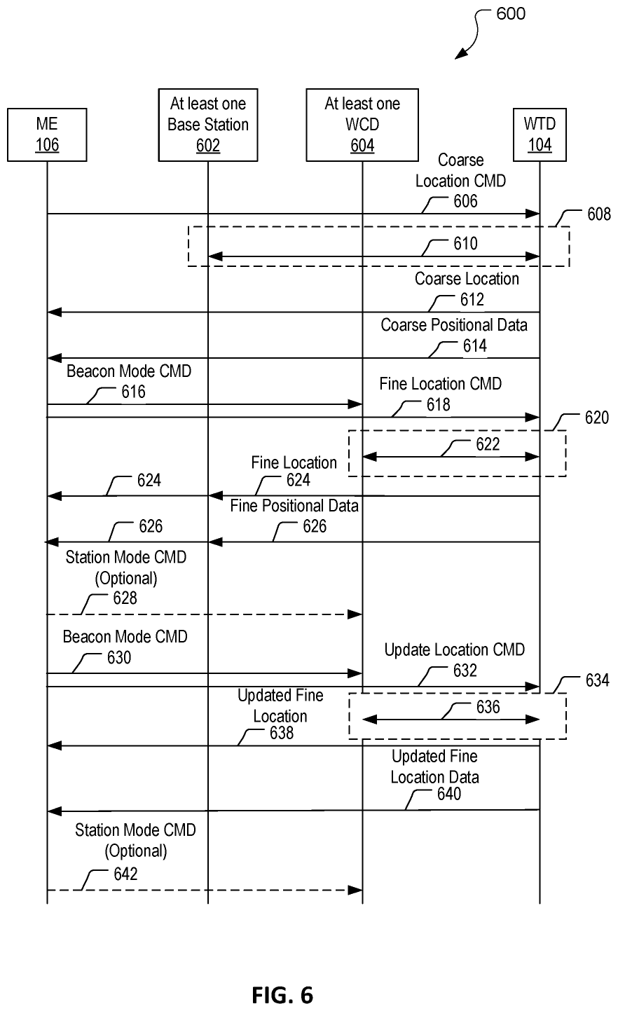

Turning to FIG. 6, a sequence diagram 600 is shown illustrating an example of an implementation of operation of the DRMS 100. In this example, signals are transmitted and received back and forth between the ME 106, at least one base station 602, at least one wireless client device 604, and the WTD 104. In this example, the at least one base station 602 may be the 1^{st} BS 112 and the at least one wireless client device 604 may be the 1^{st} WCD 116.

In an example of operation, the ME 106 transmits the coarse location command 606 to the WTD 104. The WTD 104 receives the coarse location command 606 and determines 608 the coarse location 202 of the WTD 104 utilizing at least one base station, of the plurality of base stations 108, based on the coarse location command 606. Generally, the WTD 104 transmits and receives communication, beacon, and/or acknowledgement signals 610 between the at least one base station 602 and WTD 104 to receive timing information that allows the WTD 104 to determine the coarse location 202 of the WTD 104 based on a determined distance of the WTD 104 from the at least one base station 602. In this example, the WTD 104 and at least one base station 602 may utilize RTT measurements. Once the coarse location 202 is determined, the WTD 104 may send 612 the coarse location 202 to the ME 106 or send 614 the coarse positional data to the ME 106. In this example, the WTD 104 sends 612 or 614 the coarse location or coarse positional data to the ME 106 through the at least one base station 602. If the WTD 104 is configured to determine the coarse location 202, the WTD 104 may send 612 the coarse location 202 to the ME 106 but if the WTD 104 is only configured to measure the coarse positional data but not determine the actual coarse location 202 from the coarse positional data, the WTD 104 may instead send 614 the coarse positional data and the ME 106 may utilize the coarse positional data to determine the coarse location 202 of the WTD 104.

Once the ME 106 receives either the coarse location 202 or the coarse positional data from the WTD 104, the ME 106 transmits a beacon mode command 616 to at least one wireless client device, of the plurality of wireless client devices 110, located near the WTD 104 to switch to a beacon mode based on the coarse location 202 of the WTD 104; and a fine location command 618 to the WTD 104 to determine the fine location 208 of the WTD 104 utilizing the at least one wireless client device 604. The WTD 104 receives the fine location command 618 and determines 620 the fine location 208 of the WTD 104 utilizing at least one wireless client device 604, of the plurality of wireless client device 110, based on the fine location command 618. Generally, the WTD 104 transmits and receives communication, beacon, and/or acknowledgement signals 622 between the at least one wireless client device 604 and WTD 104 to receive timing information that allows the WTD 104 to determine the fine location 208 of the WTD 104 based on a determined distance of the WTD 104 from the at least one wireless client device 604. In this example, the WTD 104 and at least one wireless client device 604 may utilize RTT measurements. Once the fine location 208 is determined, the WTD 104 may send 624 the fine location 208 to the ME 106 or send 626 the fine positional data to the ME 106. In this example, the WTD 104 sends 624 or 626 the fine location or fine positional data to the ME 106 through the at least one base station 602. If the WTD 104 is configured to determine the fine location 208, the WTD 104 may send 624 to fine location 208 to the ME 106 but if the WTD 104 is only configured to measure the fine positional data but not determine the actual fine location 208 from the fine positional data, the WTD 104 may instead send 626 the fine positional data and the ME 106 may utilize the fine positional data to determine the fine location 208 of the WTD 104. After the fine location or fine location data has been sent 624 or 626 and received by the ME 106, the ME 106 may optionally send 628 a station mode command to the at least one wireless client device 604 to switch back from the beacon mode to a station mode. If the ME 106 does not send the optional station mode command, the at least one wireless client device 604 may be configured to time out the beacon mode and automatically switch back to the station mode.

The ME 106 may also be configured to transmit a second beacon mode command 630 to the at least one wireless client device 604 to switch to the beacon mode based on the fine location 208 of the WTD 104. In this example, the at least one wireless client device 604 may be optionally the same wireless client device or a closer client device to the fine location 208 of the WTD 104 then the wireless client device (or multiple wireless client devices) that was selected for the previously for determining the fine location 208 of the WTD in previous determining state 620. The ME 106 then transmits an update location command 632 to the WTD 104 to determine the updated fine location 220 of the WTD 104 utilizing the at least one wireless client device 604. The WTD 104 receives the update location command 632 and determines 634 the updated fine location 220 of the WTD 104 utilizing at least one wireless client device 604, of the plurality of wireless client device 110, based on the update location command 632 and the previously determined fine location 208 of the WTD 104. The WTD 104, again, transmits and receives communication, beacon, and/or acknowledgement signals 636 between the at least one wireless client device 604 and WTD 104 to receive timing information that allows the WTD 104 to determine the updated fine location 220 of the WTD 104 based on a determined distance of the WTD 104 from the at least one wireless client device 604. In this example, the WTD 104 and at least one wireless client device 604 may again utilize RTT measurements.

Once the updated fine location 220 is determined, the WTD 104 may send 638 the updated fine location 220 to the ME 106 or send 640 the updated fine positional data to the ME 106. In this example, the WTD 104 sends 638 or 640 the updated fine location or updated fine positional data to the ME 106 through the at least one wireless client device 604 and the at least one base station 602. If the WTD 104 is configured to determine the updated fine location 220, the WTD 104 may send 638 the updated fine location 220 to the ME 106 but if the WTD 104 is only configured to measure the updated fine positional data but not determine the actual updated fine location 220 from the updated fine positional data, the WTD 104 may instead send 640 the updated fine positional data and the ME 106 may utilize the updated fine positional data to determine the updated fine location 220 of the WTD 104. After the updated fine location or updated fine location data has been sent 638 or 640 and received by the ME 106, the ME 106 may optionally send 642 a second station mode command to the at least one wireless client device 604 to switch back from the beacon mode to a station mode. If the ME 106 does not send the optional second station mode command, the at least one wireless client device 604 may be configured to time out the beacon mode and automatically switch back to the station mode.

In these examples, the beacon mode commands 616 and 630 may be sent to selected wireless client devices (i.e., a sub-plurality of the wireless client devices) from the plurality of the wireless client devices 110 based on a pre-determined positional accuracy for the fine location 208 or actual location 102 of the WTD 104 and a pre-determined accuracy of at least one ranging estimation based on the RTT measurement between the WTD 104 and sub-plurality of the wireless client devices. In general, the pre-determined positional accuracy and pre-determined accuracy of the at least one ranging estimation may be predetermined (e.g., predefined) desired accuracy values that are useful for the locating the WTD 104 (e.g., within a half a meter of a specific location on a shelve of a specific aisle of a store). As an example, if the commercial environment is a retail environment such as, for example, a store, the desired accuracy value may be less than 2 meters. As a further example, if there is a desire to identify a location for the correct aisle in a venue, the predetermined desired accuracy value may be less than 2 meters but if it is desired to identify another location for the correct gondola (i.e., shelving unit) in an aisle of the venue, the predetermined desired accuracy value may be less than 0.5 meters.

Further, in these examples, it is appreciated that at times the at least one wireless client device 604 may not be available because it is busy performing a specific system intensive task or is already communicating on the channel used for communicating between the at least one wireless client device 604 and the WTD 104 or other devices. In these situations, the ME 106 may optionally send a message to query the at least one wireless client device 604 for availability to switch to the beacon mode. After sending the query message, the ME 106 may determine to either transmit the beacon mode command if the at least one wireless client device 604 is available to switch or schedule to transmit the beacon mode command later if the at least one wireless client device 604 is not available to switch.

Alternatively, the ME 106 may, instead, send the beacon mode command 616 repeatedly until it receives an indication that the at least one wireless client device 604 switches to the beacon mode. In addition in this example, the beacon mode command 616 may specify a particular time in the near future, when the beacon mode will be supported, or it could specify a periodic schedule when the wireless client device is to be switched to the beacon mode.

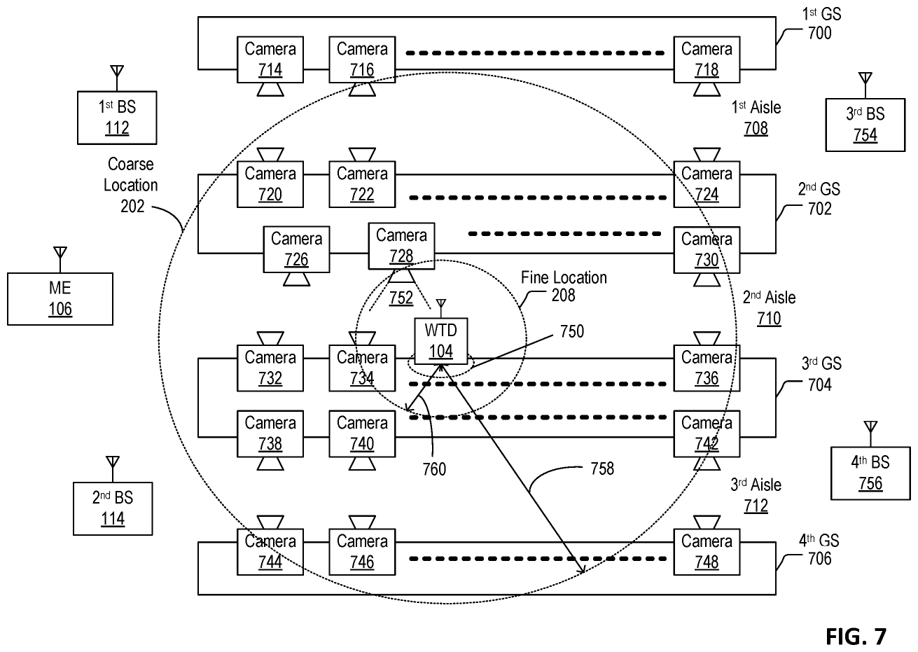

FIG. 7 is a functional system block diagram of an example of an implementation of the DRMS100 within a commercial environment in accordance with disclosure. In this example, the commercial environment may be, for example, a store having a plurality of gondolas/shelves (e.g., a first gondola/shelving (1^{st} GS 700), second gondola/shelving (2nd GS 702), third gondola/shelving (3^{rd} GS 704), and fourth gondola/shelving (4^{th} GS 706)) with merchandise placed on the gondolas/shelves. In this example, the plurality of gondolas/selves may be positioned with a plurality of aisles (e.g., 1^{st} aisle 708, 2^{nd} aisle 710, and 3^{rd} aisle 712) between the 1^{st} GS 700, 2^{nd} GS 702, 3^{rd} GS 704, and 4^{th} GS 706, respectively. Moreover, the plurality of wireless client devices 110 may be a plurality of Wi-Fi configured cameras that capture images of the merchandise on the plurality of gondolas/shelves. As an example, the 1^{st} GS 700 may include a plurality of wireless client devices that are Wi-Fi cameras 714, 716, and 718 directed towards the 2^{nd} GS 702 along the 1^{st} aisle 708. In this example, only three Wi-Fi cameras are shown for the purpose of case of illustration but it is understood that there could be many more Wi-Fi cameras placed along the 1^{st} GS 700. Similarly, in this example, the 2^{nd} GS 702 may include Wi-Fi cameras 720, 722, and 724 on a first side of the 2^{nd} GS 702 directed towards the 1^{st} GS 700 along the 1st aisle 708 and Wi-Fi cameras 726, 728, and 730 on the other side of the 2^{nd} GS 702 directed towards the 3^{rd} GS 704 along the 2^{nd} aisle 710; the 3^{rd} GS 704 may include Wi-Fi cameras 732, 734, and 736 on a first side of the 3^{rd} GS 704 directed towards the 2^{nd} GS 702 along the 2^{nd} aisle 710 and Wi-Fi cameras 738, 740, and 742 on the other side of the 3^{rd} GS 704 directed towards the 4^{th} GS 706 along the 3^{rd} aisle 712; and the 4^{th} GS 706 may include Wi-Fi cameras 744, 746, and 748 on a first side of the 4^{th} GS 706 directed towards the 3^{rd} GS 704 along the 3^{rd} aisle 712. In this example, the actual locations of the individual Wi-Fi cameras 714, 716, 718, 720, 722, 724, 726, 728, 730, 732, 734, 736, 738, 740, 742, 744, 746, and 748 may be known to the ME 106 and the locations may be stored in the at least one memory 150 of the ME 106.

In this example, the WTD 104 may be located at location 750 (corresponding to location 102 in FIGS. 1 and 2) along the 3^{rd} GS 704 facing the 2^{nd} aisle 710 and approximately opposite the Wi-Fi camera 728. The Wi-Fi camera 728 is a wireless client device, of the plurality of wireless client devices 110, that communicates with one or more of the plurality of base stations 108 that includes, for example, the 1^{st} BS 112, 2^{nd} BS 114, 3^{rd} BS 754, and 4^{th} BS 756 described previously. In this example, the Wi-Fi camera 728 may be directed towards the 3^{rd} GS 704 and is configured to capture images of the merchandise (including the WTD 104 that may be, for example, a tag on a piece of merchandise) located on the 3^{rd} GS 704. The Wi-Fi camera 728 may have a field of view 752 that has a line of sight (LOS) to and captures an image of the WTD 104. In this example, the location 750 of the WTD 104 may also be close to the locations of the Wi-Fi cameras 734 and 740.

In an example of operation as described earlier in relation to FIG. 6, the ME 106 may transmit a coarse location command 606 to the WTD 104 to determine the coarse location 202 of the WTD 104 utilizing the plurality of base stations 108. In this example, the commercial environment may include numerous Wi-Fi base stations throughout the space of the commercial environment and the ME 106 may utilize a sub-plurality of base stations that include, for example, the 1^{st} BS 112 and 2^{nd} BS 114, and a 3^{rd} BS 754 and a 4^{th} BS 756. As described previously, the WTD 104 may utilize a RTT procedure to determine the coarse location 202 of the WTD 104 having coarse radius 758 as shown. In this example, the Wi-Fi cameras 716, 720, 722, 724, 726, 728, 730, 732, 734, 736, 738, 740, 742, 744, and 746 may be located within the coarse radius 758 of the coarse location 202. In this example, the actual locations of the Wi-Fi cameras and sub-plurality of base stations may be known to the ME 106 and stored in the at least one memory 150 of the ME 106. As an example, the coarse radius 758 may be between 3 meters to 10 meters.

Since the location of the Wi-Fi cameras are known to the ME 106, the ME 106 may choose the plurality of Wi-Fi cameras 716, 720, 722, 724, 726, 728, 730, 732, 734, 736, 738, 740, 742, 744, and 746 for potentially performing the FTM procedure with the WTD 104 because they are located within the coarse radius 758 of the coarse location 202. From these Wi-Fi cameras, the ME 106 may further limit the actual communication to the one or more Wi-Fi cameras that are closest to the location 750 of the WTD 104. In this example, the ME 106 may choose to only communicate with the sub-plurality of Wi-Fi cameras that include, for example, Wi-Fi cameras 728, 730, 734, and 736 or with only Wi-Fi cameras 728 and 734 (because Wi-Fi cameras 728 and 734 are the closest to the location 750 of the WTD 104). Optionally, the ME 106 may only choose Wi-Fi camera 728 because it has the field of view 752 that can see and capture the WTD 104. The ME 106 may choose the Wi-Fi cameras based on different criteria that allow for the greatest accuracy in determining the fine location 208 of the WTD 104. These different criteria may be based on choosing Wi-Fi cameras that are likely near to and surround the WTD 104. Moreover, as an example, if positioning accuracy is good enough to determine aisle that the WTD 104 is in, then the Wi-Fi cameras within the aisle will likely have direct line of sight and will be good candidates.

In general, utilizing more Wi-Fi cameras will allow for more accuracy in the fine location 208 based on trilateration, and the particular Wi-Fi cameras may be selected based on an estimated ability to contribute to an accurate location determination for the WTD 104. The ME 106 then transmits the beacon mode command 616 to at least one wireless client device, of the plurality of wireless client devices 110, located near the WTD 104 to switch to a beacon mode based on the coarse location 202 of the WTD 104. In this example, the beacon mode command 616 may be transmitted to the, for example, Wi-Fi cameras 728, 730, 734, and 736. Then ME 106 then transmits the fine location command 618 to the WTD 104 to determine the fine location 208 of the WTD 104 utilizing the at least one wireless client device (i.e., the Wi-Fi cameras that have been selected by the ME 106 as described previously).

In this example, the WTD 104 receives the coarse location command 606 from the ME 106 and communicates the selected base stations (i.e., 1^{st} BS 112, 2^{nd} BS 114, 3^{rd} BS 754, and 4^{th} BS 756). The WTD 104 then determines the coarse location 202 of the WTD 104 utilizing the plurality of base stations based on the coarse location command 606. When the WTD 104 receives the fine location command 618 from the ME 106 based on the coarse location 202 of the WTD 104 and, in response, measures fine positional data from beacon signals of at least one wireless client devices (i.e., Wi-Fi camera 728 or, for example, Wi-Fi cameras 728, 730, 734, and 736) based on the fine location command 618, where the at least one wireless client device is in a beacon mode. In this example, the fine location 208 has a fine radius 760 that may extend to Wi-Fi cameras 728 and 734 or less. In this example, it is desirous that the fine radius 760 is minimized such that the fine location 208 corresponds to, or is approximately, the same as the location 750 of the WTD 104. The WTD 104 then transmits the fine location 208 of the WTD 104 or fine positional data to the ME 106. As an example, the fine radius 760 may be less than 1 meter if the Wi-Fi enable wireless client device has a LOS with the WTD 104.

While Wi-Fi enabled devices are discussed, it is appreciated that base stations and wireless client devices may also utilize Bluetooth for their respective connections. For example, the Wi-Fi cameras may keep Wi-Fi off most of the time, and use low power Bluetooth to received commands to communicate with ME 106, and only enable Wi-Fi when transmitting camera data, or specifically in beacon mode.

In these examples, the wireless client devices have been shown as cameras but it is appreciated that the wireless client devices may be an fixed Wi-Fi connected device, such as, for example, cameras, televisions, thermostats, printers, appliances, etc. Using the described techniques, the Wi-Fi cameras may be also utilized to validate any camera mapping in a particular aisle.

The updated fine location 220 of the WTD 104 may also be determined utilizing the Wi-Fi cameras that are closest to the fine location 208 of the WTD 104 that was previously determined. As an example, either Wi-Fi cameras 728 or 734 may be utilized for determining the updated fine location 220 of the WTD 104 since this wireless client devices have been previously determined to be closest to the fine location 208 of the WTD 104.

Because, generally, Wi-Fi type cameras are batter powered, subsequent location determinations may use alternative sets of Wi-Fi cameras to spread utilization and save on battery power. Moreover, in this example, once the fine location 208 or updated fine location 220 has been determined, the Wi-Fi cameras may revert to a station mode or even a sleep mode if they are not scheduled to capture images of the environment. Further, dynamic spreading of camera utilization could be optimized not only for power savings but for interference mitigation, and Wi-Fi camera connectivity availability.

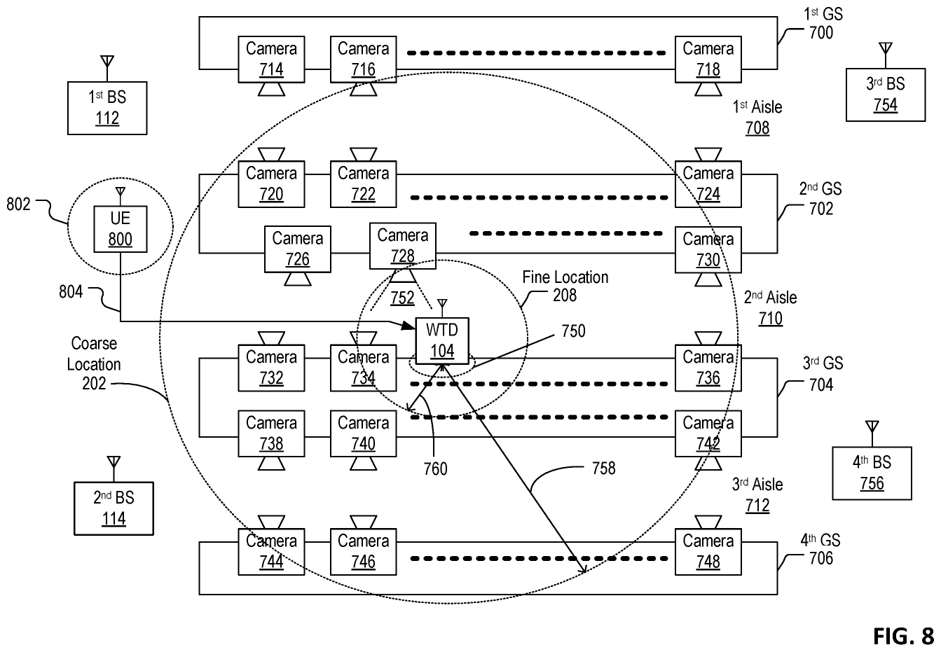

Turning to the FIG. 8, a UE 800 is shown in the commercial environment shown in FIG. 7. In this example, the ME 106 may be implemented in the UE 800 as shown and described previously in relation to UE 500 of FIG. 5. In this example, the UE 800 may have a UE location 802 that will move about within the commercial environment. The UE 800 may be, for example, a mobile device such as, for example, a tablet or smartphone having the ME 106 implemented on the UE 800 as a mobile application. As an example, if the commercial environment is a store, a user such as a store employee or buyer may utilize the UE 800 to find the location 750 of the WTD 104.

As an example of operation, the ME 106 on the UE 500 may perform the same procedures previously discussed in locating the fine location 208 of the WTD 104. Once the fine location 208 of the WTD 104, the UE 800 may direct a user of the UE 800 to the WTD 104 along a path 804. The UE 800 may utilize the UE location 802 and fine location 208 of the WTD 104 to determine the path 804 from the UE location 802 to the fine location 208 of the WTD 104. Since the UE 800 generally includes a position device such as, for example, a Satellite Positioning System and or other positioning components, the UE 800 may be configured to determine and update its UE location 802 as the UE 800 moves along the path 804. In situations where UE 800 is indoors without access to external positioning services such as, for example, satellite positioning, the previously described location techniques (i.e., beacon mode RTT) may also be utilized to locate the position (i.e., the location) of the UE 800 within the venue.

In this example, the Wi-Fi cameras may be utilized to identify the UE location 802 and as a result the location of the user utilizing the UE 800 in, for example, a particular aisle, especially during off peak hours when there a few people in the retail environment. In this example, the camera images could be linked with the UE location 802 to match, for example, a face of UE user with the UE 800 in the store for identification.

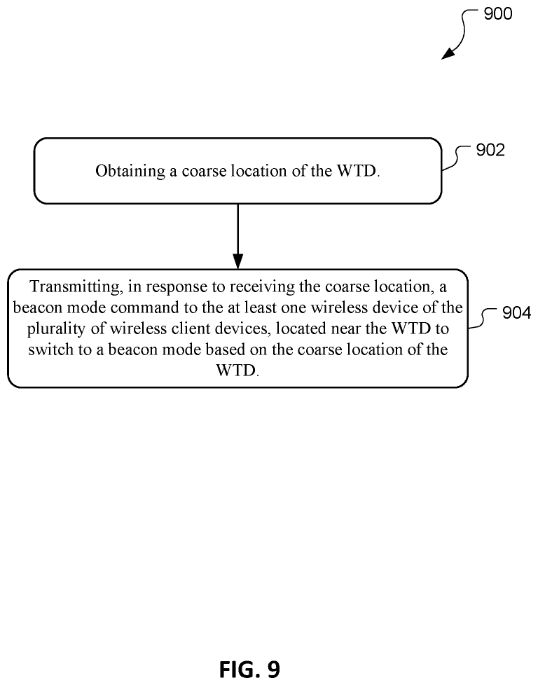

FIG. 9 is a flowchart diagram of an example of an implementation of method 900 performed by the ME 106 in determining the approximate location 102 of the WTD 104. In this example, the method 900 may include: obtaining 902 a coarse location of the WTD 104; and transmitting 904, in response to receiving the coarse location 202, a beacon mode command 616 to at least one wireless client device of a plurality of wireless client devices 110, located near the WTD 104 to switch to a beacon mode based on the coarse location of the WTD 104.

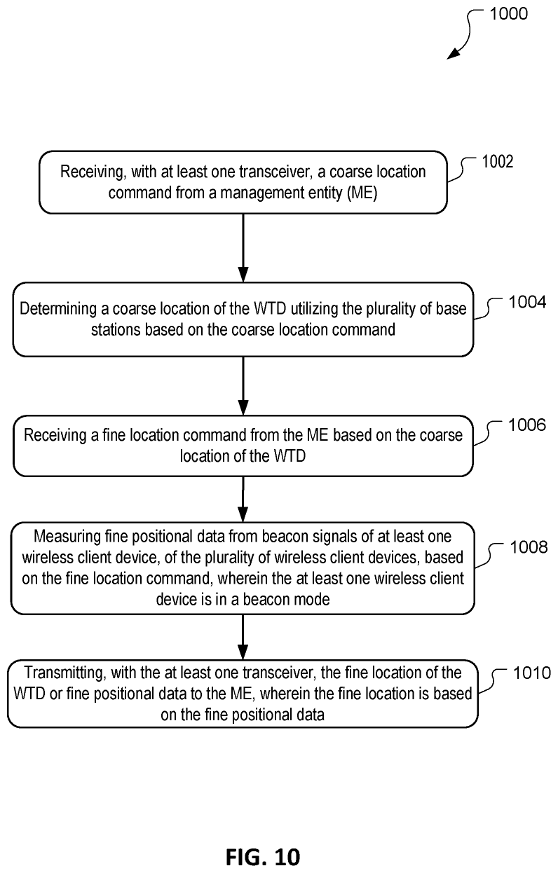

The method may also include transmitting 902 the coarse location command 606 to the WTD 104 to determine the coarse location 202 of the WTD 104 utilizing the plurality of base stations 108 and transmitting the fine location command 618 to the WTD 104 to determine the fine location 208 of the WTD 104 utilizing the at least one wireless client device. FIG. 10 is a flowchart diagram of an example of an implementation of method 1000 performed by the WTD 104 in determining the approximate location 102 of the WTD 104. In this example, the method 1000 may include: receiving 1002, with the at least one transceiver 154, the coarse location command 606 from the ME 106; determining 1004 the coarse location 202 of the WTD 104 utilizing the plurality of base stations 108 based on the coarse location command 606; receiving 1006 the fine location command 618 from the ME 106 based on the coarse location 202 of the WTD 104; measuring 1008 fine positional data from beacon signals of at least one wireless client device, of the plurality of wireless client devices 110, based on the fine location command 618, where the at least one wireless client device is in a beacon mode; and transmitting 1010 the fine location 208 of the WTD 104 or fine positional data to the ME 106, where the fine location 208 is based on the fine positional data.

### Implementation Examples

Implementation examples are provided in the following numbered clauses.

Clause 1. A management entity (ME) for determining a location of a wireless target device (WTD), the ME comprising: at least one transceiver; at least one memory; and at least one processor, in signal communication with the at least one transceiver, and the at least one memory, the at least one processor configured to: obtain a coarse location of the WTD utilizing a plurality of base stations; and transmit, in response to obtaining the coarse loation, a beacon mode command to at least one wireless client device, of a plurality of wireless client devices, located near the WTD to switch to a beacon mode based on the coarse location of the WTD.

Clause 2. The ME of clause 1, the at least one processor is further configured to transmit a fine location command to the WTD to determine a fine location of the WTD utilizing the at least one wireless client device, and wherein the at least one processor is further configured to at least one of receive the coarse location of the WTD from the WTD or determine the coarse location of the WTD from coarse positional data received from the WTD.

Clause 3. The ME of clause 2, wherein the at least one processor is further configured to at least one of receive the fine location of the WTD from the WTD or determine the fine location of the WTD from fine positional data received from the WTD.

Clause 4. The ME of clause 3, wherein the at least one processor is further configured to determine an updated fine location of the WTD utilizing the at least one wireless client device, and at least one of receive the updated fine location of the WTD from the WTD or determine the updated fine location of the WTD from updated fine positional data received from the WTD.

Clause 5. The ME of clause 3, wherein the at least one processor is configured to determine the fine location of the WTD by being further configured to perform at least one ranging estimation between the WTD and the at least one wireless client device.

Clause 6. The ME of clause 5, wherein the at least one processor is configured to transmit the beacon mode command to at least one wireless client device by being configured to transmit the beacon mode command to a sub-plurality of the wireless client devices, of the plurality of wireless devices, based on a pre-determined positional accuracy for the location of the WTD and a pre-determined accuracy of at least one ranging estimation based on a round trip time (RTT) measurement between the WTD and the sub-plurality of the wireless client devices.

Clause 7. The ME of clause 6, wherein the RTT measurement is based on a fine time measurement (FTM) between the WTD and sub-plurality of the wireless client devices.

Clause 8. The ME of clause 1, wherein the fine location command includes a first message that includes a machine address for the at least one wireless client device and a time duration of the beacon mode of the at least one wireless client device.

Clause 9. The ME of clause 2, wherein the ME is configured on a user equipment (UE), the UE includes a location determination device configured to determine a location for the UE, and the at least one processor is further configured to determine the fine location of the WTD relative to the location of the UE.

Clause 10. The ME of clause 1, wherein the at least one processor is configured to transmit the beacon mode command to the at least one wireless client device by being further configured to query the at least one wireless client device for availability to switch to the beacon mode, and determine to either transmit the beacon mode command if the at least one wireless client device is available to switch or schedule to transmit the beacon mode command if the at least one wireless client device is not available to switch.

Clause 11. The ME of clause 1, wherein the at least one processor is further configured to transmit a station mode command to the at least one wireless device to switch back from the beacon mode to a station mode.

Clause 12. The ME of clause 1, wherein the at least one processor is further configured to transmit a second beacon mode command to the at least one wireless client device, located near the WTD, to switch to the beacon mode based on the fine location of the WTD, and determine an updated location of the WTD utilizing the at least one wireless client device.

Clause 13. A method for determining a location of a wireless target device (WTD) with a management entity (ME), the method comprising: obtaining a coarse location of the WTD utilizing a plurality of base stations; and transmitting, in response to receiving the coarse location, a beacon mode command to at least one wireless client device of a plurality of wireless client devices, located near the WTD to switch to a beacon mode based on the coarse location of the WTD Clause 14. The method of clause 13, further including transmitting a fine location command to the WTD to determine a fine location of the WTD utilizing the at least one wireless client device, wherein receiving the coarse location includes receiving the coarse location of the WTD from the WTD or determining the coarse location of the WTD from coarse positional data received from the WTD.

Clause 15. The method of clause 14, further including either receiving the fine location of the WTD from the WTD or determining the fine location of the WTD from fine positional data received from the WTD.

Clause 16. The method of clause 15, further including determining an updated fine location of the WTD utilizing the at least one wireless client, and receiving the updated fine location of the WTD from the WTD or determining the updated fine location of the WTD from updated fine positional data received from the WTD.

Clause 17. The method of clause 15, wherein determining the fine location of the WTD from fine positional data includes performing at least one ranging estimation between the WTD and the at least one wireless client device.

Clause 18. The method of clause 17, wherein transmitting the beacon mode command to at least one wireless client device includes transmitting the beacon mode command to a sub-plurality of the wireless client devices, of the plurality of wireless devices, based on a pre-determined positional accuracy for the location of the WTD and a pre-determined accuracy of at least one ranging estimation based on a round trip time (RTT) measurement between the WTD and the sub-plurality of the wireless client devices.

Clause 19. The method of clause 18, wherein the RTT measurement is based on a fine time measurement (FTM) between the WTD and sub-plurality of the wireless client devices.

Clause 20. The method of clause 13, wherein the fine location command includes a first message that includes a machine address for the at least one wireless client device and a time duration of the beacon mode of the at least one wireless client device.

Clause 21. The method of clause 13, further including determining a location of user equipment (UE) that includes the ME, and determining the fine location of the WTD relative to the location of the UE.

Clause 22. The method of clause 13, further including transmitting a second beacon mode command to the at least one wireless client device, located near the WTD, to switch to the beacon mode based on the fine location of the WTD, and determining an updated location of the WTD utilizing the at least one wireless client device.

Clause 23. The method of clause 13, wherein transmitting the beacon mode command to the at least one wireless client device includes querying the at least one wireless client device for availability to switch to the beacon mode, and determining to either transmit the beacon mode command if the at least one wireless client device is available to switch or schedule to transmit the beacon mode command if the at least one wireless client device is not available to switch.

Clause 24. The method of clause 13, further including transmitting a station mode command to the at least one wireless device to switch back from the beacon mode to a station mode.

Clause 25. A management entity (ME) for determining a location of a wireless target device (WTD), the ME comprising: means for obtaining a coarse location of the WTD utilizing a plurality of base stations; means for transmitting, in response to obtaining the coarse location, a beacon mode command to at least one wireless client device of a plurality of wireless client devices, located near the WTD to switch to a beacon mode based on the coarse location of the WTD Clause 26. The ME of clause 25, further including means for transmitting a fine location command to the WTD to determine a fine location of the WTD utilizing the at least one wireless client device, and wherein the means for receiving the coarse location includes means for receiving the coarse location of the WTD from the WTD or means for determining the coarse location of the WTD from coarse positional data received from the WTD.

Clause 27. The ME of clause 26, further including either means for receiving the fine location of the WTD from the WTD or means for determining the fine location of the WTD from fine positional data received from the WTD.

Clause 28. The ME of clause 27, further including means for determining an updated fine location of the WTD utilizing the at least one wireless client device, and means for receiving the updated fine location of the WTD from the WTD or means for determining the updated fine location of the WTD from updated fine positional data received from the WTD.

Clause 29. The ME of clause 27, wherein means for determining the fine location of the WTD from fine positional data includes means for performing at least one ranging estimation between the WTD and the at least one wireless client device.

Clause 30. The ME of clause 29, wherein means for transmitting the beacon mode command to at least one wireless client device includes means for transmitting the beacon mode command to a sub-plurality of the wireless client devices, of the plurality of wireless devices, based on a pre-determined positional accuracy for the location of the WTD and a pre-determined accuracy of at least one ranging estimation based on a round trip time (RTT) measurement between the WTD and the sub-plurality of the wireless client devices.

Clause 31. The method of clause 30, wherein the RTT measurement is based on a fine time measurement (FTM) between the WTD and sub-plurality of the wireless client devices.

Clause 32. The ME of clause 25, wherein the fine location command includes a first message that includes a machine address for the at least one wireless client device and a time duration of the beacon mode of the at least one wireless client device.

Clause 33. The ME of clause 25, further including means for determining a location of user equipment (UE) that includes the ME, and means for determining the fine location of the WTD relative to the location of the UE.

Clause 34. The ME of clause 25, wherein means for transmitting the beacon mode command to the at least one wireless client device includes means for querying the at least one wireless client device for availability to switch to the beacon mode, and means for determining to either transmit the beacon mode command if the at least one wireless client device is available to switch or schedule to transmit the beacon mode command if the at least one wireless client device is not available to switch.

Clause 35. The ME of clause 25, further including means for transmitting a station mode command to the at least one wireless device to switch back from the beacon mode to a station mode.

Clause 36. The ME of clause 25, further including means for transmitting a second beacon mode command to the at least one wireless client device, located near the WTD, to switch to the beacon mode based on the fine location of the WTD, and means for transmitting an update location command to the WTD to determine an updated location of the WTD utilizing the at least one wireless client device.

Clause 37. A wireless target device (WTD) comprising: at least one transceiver; at least one memory; and at least one processor, in signal communication with the at least one transceiver, and the at least one memory, the at least one processor configured to: receive, with the at least one transceiver, a coarse location command from a management entity (ME); determine a coarse location of the WTD utilizing a plurality of base stations based on the coarse location command; receive a fine location command from the ME based on the coarse location of the WTD; measure fine positional data from beacon signals of at least one wireless client device based on the fine location command; and transmit, to the ME with the at least one transceiver, a fine location of the WTD or the fine positional data, wherein the fine location is based on the fine positional data.

Clause 38. The WTD of clause 37, wherein the at least one processor is further configured to receive an update location command from the ME, measure update fine positional data from beacon signals of at least one wireless client device based on the update location command, and transmit to the ME at least one of an updated fine location of the WTD based on determining the updated fine location utilizing the update fine positional data, or the update fine positional data.

Clause 39. The WTD of clause 37, wherein the at least one processor is configured to determine the fine location of the WTD by being further configured to perform at least one ranging estimation between the WTD and the at least one wireless client device.

Clause 40. The WTD of clause 39, wherein the at least one ranging estimation based on a round trip time (RTT) measurement between the WTD and a sub-plurality of the wireless client devices.

Clause 41. The WTD of clause 40, wherein the RTT measurement is based on a fine time measurement (FTM) between the WTD and sub-plurality of the wireless client devices.

Clause 42. The WTD of clause 37, wherein the fine location command includes a first message that includes a machine address for the at least one wireless client device and a time duration of a beacon mode of the at least one wireless client device.

Clause 43. The WTD of claim 37, wherein the at least one processor is further configured to transmit the coarse location to the ME.

Clause 44. The WTD of claim 37, wherein the WTD is a user equipment (UE).

Clause 45. A method for determining a location of a wireless target device (WTD), the method comprising: receiving, with at least one transceiver, a coarse location command from a management entity (ME); determining a coarse location of the WTD utilizing a plurality of base stations based on the coarse location command; receiving a fine location command from the ME based on the coarse location of the WTD; measuring fine positional data from beacon signals of at least one wireless client device, of a plurality of wireless client devices, based on the fine location command, wherein the at least one wireless client device is in a beacon mode; and transmitting, with the at least one transceiver, the fine location of the WTD or fine positional data to the ME, wherein the fine location is based on the fine positional data.

Clause 46. The method of clause 45, further including receiving an update location command from the ME, measuring update fine positional data from beacon signals of at least one wireless client device based on the update location command, and transmitting to the ME at least one of an updated fine location of the WTD based on determining the updated fine location utilizing the update fine positional data, or the update fine positional data.

Clause 47. The method of clause 45, wherein determining the fine location of the WTD includes performing at least one ranging estimation between the WTD and the at least one wireless client device.

Clause 48. The method of clause 47, wherein the at least one ranging estimation based on a round trip time (RTT) measurement between the WTD and a sub-plurality of the wireless client devices.

Clause 49. The method of clause 48, wherein the RTT measurement is based on a fine time measurement (FTM) between the WTD and sub-plurality of the wireless client devices.

Clause 50. The method of clause 45, wherein the fine location command includes a first message that includes a machine address for the at least one wireless client device and a time duration of a beacon mode of the at least one wireless client device.

Clause 51. The method of claim 45, further including transmitting the coarse location to the ME.

Clause 52. The method of claim 45, wherein the WTD is a user equipment (UE).

Clause 53. A wireless target device (WTD) comprising: means for receiving, a coarse location command from a management entity (ME); means for determining a coarse location of the WTD utilizing a plurality of base stations based on the coarse location command; means for receiving a fine location command from the ME based on the coarse location of the WTD; means for measuring fine positional data from beacon signals of at least one wireless client device, of the plurality of wireless client devices, based on the fine location command, wherein the at least one wireless client device is in a beacon mode and the plurality of wireless client devices are in signal communication with the plurality of base stations; and means for transmitting the fine location of the WTD or fine positional data to the ME, wherein the fine location is based on the fine positional data.

Clause 54. The WTD of clause 53, further including means for receiving an update location command from the ME, means for measuring update fine positional data from beacon signals of at least one wireless client device based on the update location command, and means for transmitting to the ME at least one of an updated fine location of the WTD based on determining the updated fine location utilizing the update fine positional data, or the update fine positional data.

Clause 55. The WTD of clause 53, wherein means for determining the fine location of the WTD includes means for performing at least one ranging estimation between the WTD and the at least one wireless client device.

Clause 56. The WTD of clause 55, wherein the at least one ranging estimation based on a round trip time (RTT) measurement between the WTD and a sub-plurality of the wireless client devices.

Clause 57. The WTD of clause 56, wherein the RTT measurement is based on a fine time measurement (FTM) between the WTD and sub-plurality of the wireless client devices.

Clause 58. The WTD of clause 53, wherein the fine location command includes a first message that includes a machine address for the at least one wireless client device and a time duration of a beacon mode of the at least one wireless client device.

Clause 59. The WTD of claim 53, further including means for transmitting the coarse location to the ME.

Clause 60. A non-transitory processor-readable storage medium comprising processor-readable instructions configured to cause one or more processors of a management entity (ME) to determine a location of a wireless target device (WTD), comprising: code for obtaining a coarse location of the WTD; and code for transmitting a beacon mode command to at least one wireless client device of the plurality of wireless client devices, located near the WTD to switch to a beacon mode based on the coarse location of the WTD.

Clause 61. A non-transitory processor-readable storage medium comprising processor-readable instructions configured to cause one or more processors of a wireless target device (WTD) to determine a location of the WTD, comprising: code for receiving a coarse location command from a management entity (ME); code for determining a coarse location of the WTD utilizing a plurality of base stations based on the coarse location command; code for receiving a fine location command from the ME based on the coarse location of the WTD; code for measuring fine positional data from beacon signals of at least one wireless client device, of the plurality of wireless client devices, based on the fine location command, wherein the at least one wireless client device is in a beacon mode and the plurality of wireless client devices are in signal communication with the plurality of base stations; and code for transmitting the fine location of the WTD or fine positional data to the ME, wherein the fine location is based on the fine positional data.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed:

1. A management entity (ME) for determining a location of a wireless target device (WTD), the ME comprising:
at least one transceiver;
at least one memory; and
at least one processor, in signal communication with the at least one transceiver, and the at least one memory, the at least one processor configured to:
obtain a coarse location of the WTD; and
transmit, in response to obtaining the coarse location, a beacon mode command to at least one wireless client device, of a plurality of wireless client devices, located near the WTD to switch to a beacon mode based on the coarse location of the WTD.

2. The ME of claim 1, wherein
the at least one processor is further configured to transmit a fine location command to the WTD to determine a fine location of the WTD utilizing the at least one wireless client device, and
the at least one processor is configured to receive the coarse location by being further configured to at least one of
receive the coarse location of the WTD from the WTD or
determine the coarse location of the WTD from coarse positional data received from the WTD.

3. The ME of claim 2, wherein
the at least one processor is further configured to at least one of
receive the fine location of the WTD from the WTD or
determine the fine location of the WTD from fine positional data received from the WTD.

4. The ME of claim 3, wherein the at least one processor is further configured to
determine an updated fine location of the WTD utilizing the at least one wireless client device, and at least one of
receive the updated fine location of the WTD from the WTD or
determine the updated fine location of the WTD from updated fine positional data received from the WTD.

5. The ME of claim 3, wherein the at least one processor is configured to determine the fine location of the WTD by being further configured to perform at least one ranging estimation between the WTD and the at least one wireless client device.

6. The ME of claim 5, wherein the at least one processor is configured to transmit the beacon mode command by being configured to transmit the beacon mode command to a sub-plurality of the wireless client devices, of the plurality of wireless devices, based on
a pre-determined positional accuracy for the location of the WTD and
a pre-determined accuracy of at least one ranging estimation based on a round trip time (RTT) measurement between the WTD and the sub-plurality of the wireless client devices.

7. The ME of claim 2, wherein
the ME is configured on a user equipment (UE),
the UE includes a location determination device configured to determine a location for the UE, and
the at least one processor is further configured to determine the fine location of the WTD relative to the location of the UE.

8. The ME of claim 2, wherein the at least one processor is further configured to
transmit a second beacon mode command to the at least one wireless client device, located near the WTD, to switch to the beacon mode based on the fine location of the WTD, and
determine an updated location of the WTD utilizing the at least one wireless client device.

9. The ME of claim 1, wherein the at least one processor is configured to transmit the beacon mode command to the at least one wireless client device by being further configured to
query the at least one wireless client device for availability to switch to the beacon mode, and
determine to either
transmit the beacon mode command if the at least one wireless client device is available to switch or
schedule to transmit the beacon mode command if the at least one wireless client device is not available to switch.

10. A method for determining a location of a wireless target device (WTD) with a management entity (ME), the method comprising:
obtaining a coarse location of the WTD; and
transmitting, in response to receiving the coarse location, a beacon mode command to at least one wireless client device of a plurality of wireless client devices, located near the WTD to switch to a beacon mode based on the coarse location of the WTD.

11. The method of claim 10, further including transmitting a fine location command to the WTD to determine a fine location of the WTD utilizing the at least one wireless client device,
wherein receiving the coarse location includes
receiving the coarse location of the WTD from the WTD or determining the coarse location of the WTD from coarse positional data received from the WTD.

12. The method of claim 11, further including either
receiving the fine location of the WTD from the WTD or
determining the fine location of the WTD from fine positional data received from the WTD.

13. The method of claim 12, further including
determining an updated fine location of the WTD utilizing the at least one wireless client device, and
receiving the updated fine location of the WTD from the WTD or
determining the updated fine location of the WTD from updated fine positional data received from the WTD.

14. The method of claim 12, wherein determining the fine location of the WTD from fine positional data includes performing at least one ranging estimation between the WTD and the at least one wireless client device.

15. The method of claim 14, wherein transmitting the beacon mode command to at least one wireless client device includes transmitting the beacon mode command to a sub-plurality of the wireless client devices, of the plurality of wireless devices, based on
a pre-determined positional accuracy for the location of the WTD and
a pre-determined accuracy of at least one ranging estimation based on a round trip time (RTT) measurement between the WTD and the sub-plurality of the wireless client devices.

16. The method of claim 11, further including
determining a location of user equipment (UE) that includes the ME, and
determining the fine location of the WTD relative to the location of the UE.

17. The method of claim 11, further including
transmitting a second beacon mode command to the at least one wireless client device, located near the WTD, to switch to the beacon mode based on the fine location of the WTD, and
transmitting an update location command to the WTD to determine an updated location of the WTD utilizing the at least one wireless client device.

18. The method of claim 10, wherein transmitting the beacon mode command to the at least one wireless client device includes
querying the at least one wireless client device for availability to switch to the beacon mode, and
determining to either
transmit the beacon mode command if the at least one wireless client device is available to switch or
schedule to transmit the beacon mode command if the at least one wireless client device is not available to switch.

19. A wireless target device (WTD) comprising:
at least one transceiver;
at least one memory; and
at least one processor, in signal communication with the at least one transceiver, and the at least one memory, the at least one processor configured to:
receive, with the at least one transceiver, a coarse location command from a management entity (ME);
determine a coarse location of the WTD utilizing a plurality of base stations based on the coarse location command;
receive a fine location command from the ME based on the coarse location of the WTD;
measure fine positional data from beacon signals of at least one wireless client device based on the fine location command; and
transmit, to the ME with the at least one transceiver, a fine location of the WTD or the fine positional data, wherein the fine location is based on the fine positional data.

20. The WTD of claim 19, wherein the WTD is a user equipment (UE).
